(19) United States
(12) Patent Application Publication
(10) Pub. No.: US 2007/0146599 A1
(43) Pub. Date: Jun. 28, 2007

(54) LIQUID CRYSTAL DISPLAY DEVICE AND METHOD FOR MANUFACTURING THE SAME

(75) Inventors: Tatsuo UCHIDA, Miyagi-ken (JP); Takahiro Ishinabe, Miyagi-ken (JP); Tetsuya Miyashita, Miyagi-ken (JP); Ken Kuboki, Miyagi-ken (JP); Mitsuru Kano, Fukushima-ken (JP); Yuzo Hayashi, Fukushima-ken (JP); Yohei Iida, Fukushima-ken (JP); Mitsuo Oizumi, Fukushima-ken (JP)

Correspondence Address: BRINKS HOFER GILSON & LIONE, P.O. BOX 10395, CHICAGO, IL, 60610, US

(73) Assignees: ALPS ELECTRIC CO., LTD., Tokyo (JP); TOHOKU UNIVERSITY, Miyagi (JP)

(21) Appl. No.: 11/615,760

(22) Filed: Dec. 22, 2006

(30) Foreign Application Priority Data
Dec. 22, 2005 (JP) 2005-370695
Dec. 28, 2005 (JP) 2005-378753

(51) Int. Cl. G02F 1/1337

(52) U.S. Cl. 349/129

(57) ABSTRACT

A liquid crystal display device is provided. In the liquid crystal display device, a whole face of an alignment layer disposed above a substrate is uniformly subjected to first alignment treatment (uniform treatment) such as rubbing treatment in an a direction. Second alignment treatment is performed in a b direction (second direction) making an angle of about 90 degrees with the a direction and in a c direction (third direction) opposite to the a direction such that regions narrow than regions subjected to the first alignment treatment. This allows micro-regions subjected to alignment treatment in the a, b, and/or c direction to be present at intersections of zones extending in the b or c direction. The micro-regions are located in light-shielding sections.

### BACKGROUND

1. Field

The present embodiments relate to an optically compensated birefringence or bend (OCB)-mode liquid crystal display device having a wide viewing angle and high response speed and also relates to a method for manufacturing such a liquid crystal display device.

2. Description of the Related Art

In recent years, in liquid crystal display devices, a display mode called an OCB mode has been attracting much attention as discussed in Y. Yamaguchi, et al., “Wide-Viewing-Angle Display Mode for the Active-Matrix LCD Using Bend-Alignment Liquid Crystal Cell”, SID 93 Digest, p. 277 (hereinafter referred to as Non-patent Document 1) and C-L. Kuo, et al., “Improvement of Gray-Scale Performance of Optically Compensated Birefringence (OCB) Display Mode for AMLCDs”, SID 94 Digest, pp. 927 (hereinafter referred to as Non-patent Document 2).

The OCB mode is useful in achieving a wide viewing angle and high response speed using a liquid crystal panel and an optical compensation film in combination. In the liquid crystal panel, a liquid crystal layer which is sandwiched between a pair of substrates and which is oriented in a splay alignment is oriented in a bend alignment by the application of a driving voltage. The optical compensation film is used for the optical compensation of the liquid crystal panel.

In the OCB mode, if ordinary alignment treatment is performed, the liquid crystal layer initially oriented in the splay alignment cannot be readily oriented in the bend alignment quickly. Even if the pre-tilt angle on the substrates is set to about ten degrees, a large voltage of about 10 to 20 V is necessary. The application of such a large voltage is very difficult due to the control of a driving voltage. It is difficult to allow the transformation of the liquid crystal layer to occur in all pixels. Therefore, some of the pixels in which the transformation of the liquid crystal layer does not occur are evaluated to be defects and seriously deteriorate the quality of an image displayed on the panel.

In order to solve such a problem, various techniques have been proposed. For example, Japanese Patent No. 3539727 (hereinafter referred to as Patent Document 1) discloses an OCB-mode liquid crystal display device including a first substrate having a groove and a second substrate (a counter substrate). The groove is rubbed in a first direction that is parallel to the longitudinal direction thereof and the first and second substrates are rubbed in a second direction that is different from the first direction. The first and second directions make an angle of 45 to 135 degrees.

Japanese Unexamined Patent Application Publication No. 2002-169160 (hereinafter referred to as Patent Document 2) discloses a liquid crystal display device including a substrate having first regions that are different in alignment from second regions. The first regions are formed in such a manner that the substrate is rubbed and structures such as irregularities, pillars, or bumps are partly provided on the substrate. Liquid crystal molecules located above the first regions are twisted by voltage application. Since the resulting molecules serve as transformation nuclei, the transformation from a splay alignment to a bend alignment readily occurs.

When mobile apparatuses such as mobile phones and personal digital assistants (PDAs) include OCB-mode liquid crystal display devices, it takes several seconds or more to allow the transformation to a bend alignment to occur in whole screens with a voltage of several volts during standby even if the above techniques are use; hence, the mobile apparatuses are not suitable for practical. Assuming that the mobile apparatuses are driven with batteries, voltages greater than 10 V need to be applied to the devices. Therefore, the life of the batteries is problematic. When large irregular structures are densely arranged on substrates such that bend transformation occurs quickly from transformation nuclei with high reproducibility, it is difficult to manufacture panels including the substrates. Even if bend transformation occurs partly, it is substantially impossible to allow bend transformation to occur in whole display regions.

### SUMMARY

The present embodiments may obviate one or more of the limitations or drawbacks of the related art. For example, in one embodiment, a liquid crystal display device including a liquid crystal layer containing liquid crystal molecules of which the arrangement can be quickly converted from a splay alignment to a bend alignment with high reproducibility without applying a large voltage to the liquid crystal layer. It is another object of the present invention to provide a method for manufacturing such a liquid crystal display device.

In one embodiment, a liquid crystal display device includes a pair of substrates including electrodes and alignment control layers and a liquid crystal layer, disposed between the substrates, having positive dielectric anisotropy. The alignment control layers are subjected to surface alignment treatment such that liquid crystal molecules which are contained in the liquid crystal layer and which are located close to the alignment control layers make pre-tilt angles with the substrates in directions opposite to each other in at least an initial state and the transformation from a splay alignment to a buffer layer is allowed to occur by voltage application in such a manner that the twist alignment of the liquid crystal molecules is once transformed to twist alignments different from each other. Spots at which the transformation starts are micro-regions arranged over a face of a panel. The micro-regions are arranged in light-shielding sections. The alignment control layers may include regions subjected to optical alignment treatment.

According to this configuration, although the liquid crystal display device has a simple panel structure, the transformation from a splay alignment to a bend alignment is allowed to occur quickly in the liquid crystal display device with a small voltage of several volts with high reproducibility. This is because the transformation, which is the key to allow OCB-mode liquid crystal display devices to display images, starts at spots which have a fine width, which are present in a wide region uniformly subjected to alignment treatment, and which are subjected to alignment treatment in two different directions. Since the micro-regions are arranged in light-shielding sections, disclination regions located near the spots at which the transformation starts can be covered with the light-shielding sections.

In the liquid crystal display device, the micro-regions have a small width and are preferably arranged above an active matrix substrate.

The liquid crystal display device preferably further includes at least one polarizing film and a plurality of retardation films located outside the substrates.

A method for manufacturing a liquid crystal display device according to one embodiment includes preparing a first and a second substrate including electrodes and alignment control layers; subjecting the alignment control layers to surface alignment treatment such that liquid crystal molecules which are contained in a liquid crystal layer and which are located close to the alignment control layers make pre-tilt angles with the first and second substrates in directions opposite to each other in at least an initial state and the transformation from a splay alignment to a buffer layer is allowed to occur by voltage application in such a manner that the twist alignment of the liquid crystal molecules is once transformed to twist alignments different from each other; and forming micro-regions from which spots at which the transformation starts arise in light-shielding sections, arranging the first and second substrates such that the electrodes are opposed to the alignment control layers, and then providing the liquid crystal layer between the first and second substrates.

In one embodiment, subjecting the alignment control layers to the surface alignment treatment preferably includes subjecting the alignment control layers to first alignment treatment in a first direction; subjecting narrow regions present in the alignment control layers to second alignment treatment in a second direction substantially perpendicular to the first direction and then in a third direction opposite to the first direction, this being subsequent to the act in which the first alignment treatment is performed; and subjecting the alignment control layer of the substrate opposed to the substrate having the alignment control layer subjected to the first alignment treatment and the second alignment treatment to third alignment treatment in a direction that is substantially the same as the first direction.

In the method, the second direction preferably makes an angle of about 90±20 degrees with the first direction.

In the method, the anchoring forces of the alignment control layers subjected to the first alignment treatment and the second alignment treatment are preferably controlled such that the first direction is greater than the second and/or third direction.

In the method, the surface alignment treatment is preferably rubbing treatment.

In the method, the alignment control layers preferably include first regions uniformly subjected to first alignment treatment in a first direction and second regions formed by subjecting the micro-regions present in the alignment control layers to second alignment treatment, subsequent to first alignment treatment, in a second direction substantially perpendicular to the first direction and in a third direction opposite to the first direction.

In the method, the second regions are preferably subjected to optical alignment treatment.

A method for manufacturing a liquid crystal display device according to another embodiment includes preparing a first substrate including an electrode and a second substrate including an alignment control layer; subjecting the alignment control layer to surface alignment treatment such that liquid crystal molecules which are contained in a liquid crystal layer and which are located close to the alignment control layer of the second substrate make pre-tilt angles with the first and second substrates in directions opposite to each other in at least an initial state and the transformation from a splay alignment to a buffer layer is allowed to occur by voltage application in such a manner that the twist alignment of the liquid crystal molecules is once transformed to twist alignments different from each other; and providing the liquid crystal layer between the first and second substrates. Subjecting the alignment control layer to the surface alignment treatment includes subjecting the alignment control layer to first alignment treatment in a first direction; subjecting micro-regions present in the alignment control layer to second alignment treatment in a second direction substantially perpendicular to the first direction and then in a third direction opposite to the first direction, this act being subsequent to the act in which first alignment treatment is performed; and subjecting the alignment control layer of the substrate, opposed to the substrate having the alignment control layer subjected to the first alignment treatment and the second alignment treatment, to third alignment treatment in a direction that is substantially the same as the first direction and the first alignment treatment and the second alignment treatment include optical alignment treatment.

In this method, the first alignment treatment is preferably rubbing treatment and the second alignment treatment performed in the second or third direction is preferably optical alignment treatment.

In this method, the first alignment treatment is preferably optical alignment treatment and the second alignment treatment performed in the second or third direction is preferably rubbing treatment.

In this method, the optical alignment treatment provides orientation properties to a photo-orientable polymer using polarized ultraviolet light.

In one embodiment, a liquid crystal display device includes a pair of substrates including electrodes and alignment control layers and a liquid crystal layer, disposed between the substrates, having positive dielectric anisotropy. The alignment control layers are subjected to surface alignment treatment such that liquid crystal molecules which are contained in the liquid crystal layer and which are located close to the alignment control layers make pre-tilt angles with the substrates in directions opposite to each other in at least an initial state and the transformation from a splay alignment to a buffer layer is allowed to occur by voltage application in such a manner that the twist alignment of the liquid crystal molecules is once transformed to twist alignments different from each other.

Spots at which the transformation starts are micro-regions arranged over a face of a panel. The alignment control layers contain a photo-orientable polymer. In the liquid crystal display device, the arrangement of the liquid crystal molecules in the liquid crystal layer can be quickly changed from a splay alignment to a bend alignment with high reproducibility without applying a high voltage to the liquid crystal layer.

### BRIEF DESCRIPTION OF THE DRAWINGS

FIG. 1 is an exploded perspective view of a liquid crystal display device according to one embodiment;

FIG. 2 is a sectional view of the liquid crystal display device shown in FIG. 1;

FIG. 3 is an enlarged view of an active matrix substrate included in the liquid crystal display device shown in FIG. 1;

FIG. 4 is an illustration showing the alignment treatment of the liquid crystal display device shown in FIG. 1;

FIGS. 5A and 5B are illustrations showing the optical alignment treatment of a liquid crystal display device of Example 2;

FIGS. 6A to 6E are illustrations showing the orientation of an alignment control layer included in the liquid crystal display device shown in FIG. 1;

FIG. 7 is an illustration showing the relationship between alignment directions and wiring lines included in the liquid crystal display device shown in FIG. 1;

FIG. 8 is an illustration showing the orientation of an alignment control layer included in a liquid crystal display device of Example 1;

FIG. 9 is an illustration showing the orientation of an alignment control layer included in a liquid crystal display device of Example 2;

FIG. 10 is an illustration showing the orientation of the alignment control layer included in the liquid crystal display device of Example 2;

FIG. 11A is a schematic view of a rubbing roller used in manufacturing a liquid crystal display device of Example 3 and FIG. 11 B is an enlarged view of Portion XIB in FIG. 11A;

FIG. 12 is an illustration showing the orientation of an alignment control layer included in the liquid crystal display device of Example 3;

FIG. 13 is an illustration showing the relationship between the number of transformation-starting spots and the time of transformation;

FIG. 14 is an illustration showing the relationship between the number of transformation-starting spots and the time of transformation;

FIG. 15 is an illustration showing the relationship between the number of transformation-starting spots and the time of transformation; and

FIG. 16 is an illustration showing the alignment treatment of an alignment control layer included in a liquid crystal display device of a comparative example.

### DESCRIPTION OF THE PREFERRED EMBODIMENTS

The inventors have investigated conditions for allowing the splay-bend transformation to occur in OCB-mode liquid crystal display devices and found that the splay-bend transformation can be quickly induced with high reproducibility in such a manner that characteristic disclination is caused in micro-regions between pixels.

The essence of the present embodiments is that surface alignment treatment is performed such that liquid crystal molecules which are contained in a liquid crystal layer and which are located close to alignment control layers make pre-tilt angles with a pair of substrates in directions opposite to each other in at least an initial state and the transformation from a splay alignment to a bend alignment is allowed to occur by voltage application in such a mode that the twist alignment of the liquid crystal molecules is once transformed to twist alignments different from each other; hence, the splay-bend transformation is allowed to occur quickly with high reproducibility by causing characteristic disclination. The transformation starts at micro-regions that are arranged over a face of a panel at a predetermined density.

Embodiments will now be described in detail with reference to the accompanying drawings. In the accompanying drawings, characteristic portions are shown in an enlarged manner such that features thereof can be readily understood.

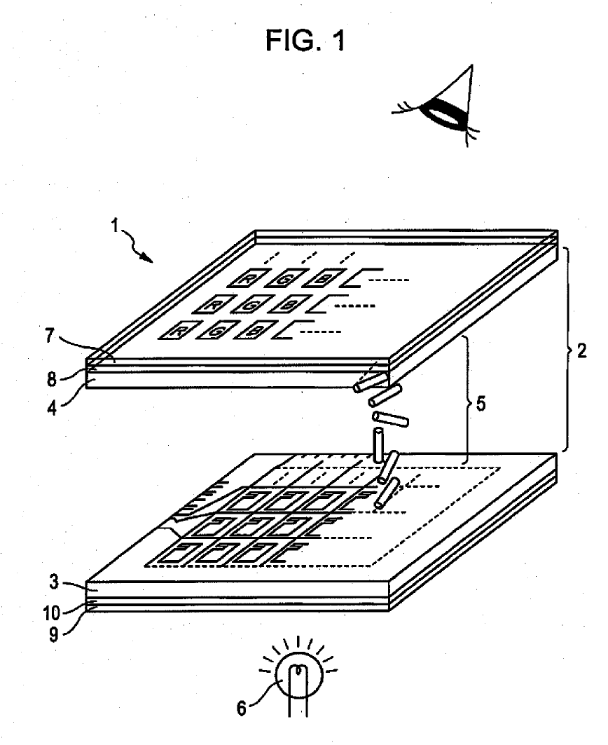

FIG. 1 shows a liquid crystal display device 1 according to one embodiment. The liquid crystal display device 1 includes a liquid crystal panel 2. The liquid crystal panel 2 is a transmissive type of active matrix-addressed color liquid crystal panel. In the liquid crystal panel 2, three dots (sub-pixels) corresponding to the three primary colors, which are red, green, and blue, form each pixel. The liquid crystal panel 2 displays a color image by controlling the pixels to be turned on or off using active driving elements connected to the respective dots. With reference to FIG. 1, the sub-pixels corresponding to red, green, and blue are arranged in a striped pattern. The sub-pixels may be arranged diagonally or in a triangular pattern.

The liquid crystal panel 2 includes a first substrate 3 located on the side opposite to a visible side; a second substrate 4, opposed to the first substrate 3, located on the visible side; a liquid crystal layer 5, sandwiched between the first and second substrates 3 and 4, serving as a light-modulating layer; a light source 6 disposed below the first substrate 3; a first polarizing film 7 disposed above the second substrate 4; at least one first retardation film 8; a second polarizing film 9 disposed below the first substrate 3; and at least one second retardation film 10.

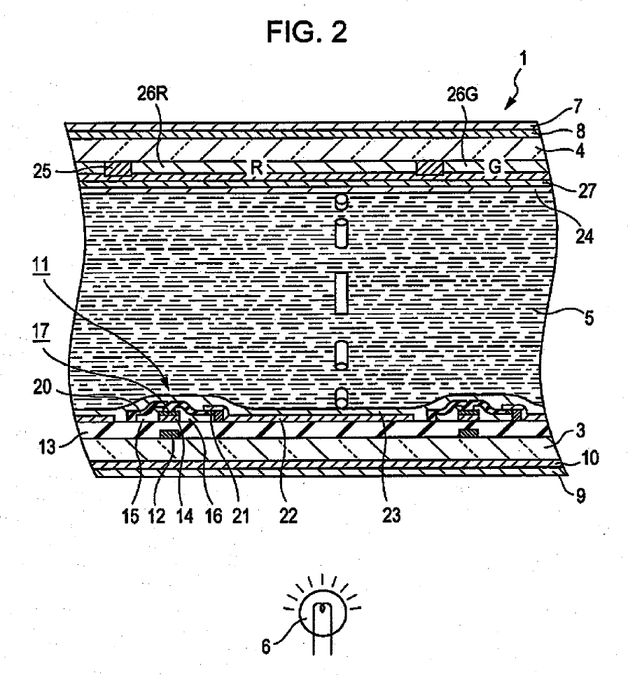

The first and second substrates 3 and 4 are made of glass or plastic, are light-transmissive, and have a rectangular shape. The distance between the first and second substrates 3 and 4 is kept constant with spherical spacers (not shown) that are dispersed in the liquid crystal layer 5 or fixed to predetermined locations. Outer regions of the first and second substrates 3 and 4 are joined to each other with a sealant (not shown) such as an epoxy resin in a sealed manner. A transparent electrode, which is not shown, extends over the second substrate 4. With reference to FIG. 2, a first alignment control layer 23 for controlling the alignment of the liquid crystal layer 5 is disposed above a face of the first substrate 3 that is directed to the liquid crystal layer 5 and a second alignment control layer 24 for controlling the alignment of the liquid crystal layer 5 is disposed above a face of the second substrate 4 that is directed to the liquid crystal layer 5.

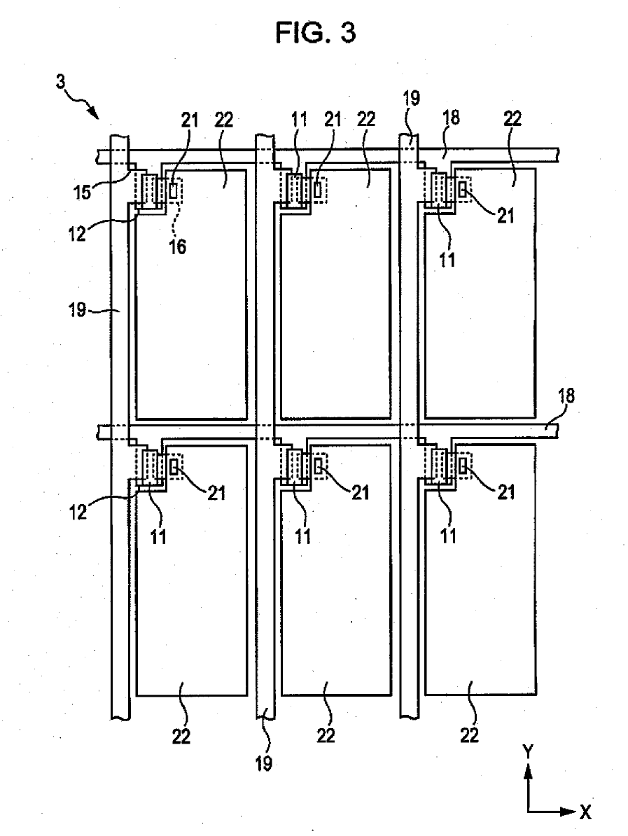

The first substrate 3 is an active matrix type as shown in FIGS. 2 and 3. Thin-film transistors (TFTs) 11 serving as switching elements are arranged, in a matrix pattern, above the face of the first substrate 3 that is directed to the liquid crystal layer 5. The TFTs 11 include gate electrodes 12, portions of a gate insulating layer 13, semiconductor layers 14, source electrodes 15, and drain electrodes 16, these layers and electrodes being arranged on the first substrate 3 in that order. That is, the TFTs 11 have an inverted staggered structure. The gate insulating layer 13 extends over the gate electrodes 12. The semiconductor layers 14 have an island shape and are arranged on the gate insulating layer 13 so as to cover the gate electrodes 12. Each source electrode 15 is located close to one end of each semiconductor layer 14 and each drain electrode 16 is located close to the other end thereof. First insulating layers 17 having an island shape are disposed on the respective semiconductor layers 14; hence, the source and drain electrodes 15 and 16 are electrically insulated from each other with the first insulating layers 17. The first insulating layers 17 function as etching stoppers for protecting the semiconductor layers 14 during the formation of the semiconductor layers 14.

The gate electrodes 12 are electrically connected to scanning lines 18. The scanning lines 18 are arranged above the face of the first substrate 3 that is directed to the liquid crystal layer 5 and extend in parallel to each other in an X direction (line direction) indicated by Arrow X in FIG. 3. The source electrodes 15 are electrically connected to signal lines 19. The signal lines 19 are also arranged above the face of the first substrate 3 that is directed to the liquid crystal layer 5 and extend in parallel to each other in a Y direction (column direction) indicated by Arrow Y in FIG. 3. The TFTs 11 are located near the intersections of the scanning and signal lines 18 and 19. Rectangular sections partitioned by the scanning and signal lines 18 and 19 correspond to respective first dot-corresponding sections arranged above the first substrate 3 in a matrix pattern. The first dot-corresponding sections form each display region included in the liquid crystal panel 2. The following drivers, which are not shown, are arranged outside the display regions: a scanning driver for applying selection signals to the scanning lines 18 and a signal deriver for applying signal voltages to the signal lines 19.

A second insulating layer 20 lies above the face of the first substrate 3 that is directed to the liquid crystal layer 5. The substrate 20 covers the TFTs 11, the scanning lines 18, and the signal lines 19. Contact holes 21 extend through the second insulating layer 20 to the drain electrodes 16. A plurality of pixel electrodes 22 are arranged on the second insulating layer 20 in a matrix pattern so as to correspond to the dots. The pixel electrodes 22 are electrically connected to the drain electrodes 16 with the contact holes 21. The pixel electrodes 22 are made of a transparent conductive material such as indium tin oxide (ITO), have a rectangular shape, and cover the respective first dot-corresponding sections. The first alignment control layer 23, which is treated as described below, extends over the pixel electrodes 22 arranged above the first substrate 3.

The following layers and electrode are arranged below the face of the second substrate 4 that is directed to the liquid crystal layer 5: the second alignment control layer 24 treated as described below, a counter electrode 27 made of a transparent conductive material such as ITO, a light-shielding black matrix layer 25 having a rectangular shape, red color filter layers 26R, green color filter layers 26G, and blue color filter layers 26B (not shown in FIG. 2). The red, green, and blue color filter layers 26R, 26G, and 26B are partitioned by portions of the black matrix layer 25. Rectangular sections partitioned by portions of the black matrix layer 25 correspond to respective second dot-corresponding sections arranged below the second substrate 4.

The black matrix layer 25 functions as a light shield for preventing the mixing of color lights emitted through the red, green, and blue color filter layers 26R, 26B, and 26B. The second dot-corresponding sections each correspond to red, green, or blue and are arranged in the light-shielding black matrix layer 25 in a spaced manner. The red, green, and blue color filter layers 26R, 26G, and 26B are periodically arranged in a mosaic pattern such as striped pattern, a diagonal pattern, or a triangular pattern. Therefore, the colors of the pixels can be controlled by applying driving voltages between the pixel electrodes 22 and the counter electrode 27 depending on the first and second dot-corresponding sections corresponding to red, green, or blue. This allows a desired image to be displayed.

The liquid crystal layer 5 is sandwiched between the first and second alignment control layers 23 and 24 in a sealed manner and contains a nematic liquid crystal composition having positive dielectric anisotropy. In an initial state (a voltage-free state or a low-voltage state causing no change in alignment), the liquid crystal layer 5 is controlled such that molecules of a liquid crystal contained in the nematic liquid crystal composition are arranged in a splay alignment in which the liquid crystal molecules located above the first substrate 3 have a pre-tilt angle different from that of those above the second substrate 4.

In the liquid crystal display device, a plurality of optical films such as retardation films and polarizing films are arranged above a panel containing liquid crystal molecules oriented as described below such that appropriate optical compensation conditions are satisfied depending on the voltage for driving the liquid crystal molecules.

In order to perform transmissive display in a normally black mode, the following films are each placed above or below the panel (including a pair of substrates and a nematic liquid crystal composition, sandwiched therebetween, having positive dielectric anisotropy) such that the birefringence phase difference between a liquid crystal layer included in the panel and the films is equal to zero: biaxial optical compensation films (that satisfy the inequality nₓ>n_{y}>n_{z}, wherein x and y represent respective in-plane directions in the panel and z represents the thickness direction of the panel) having optical axes perpendicular to the rubbing direction thereof. Conditions (the directions of optical axes, the phase difference, and the like) of the optical films are set such that a black image is displayed with the lowest voltage (OFF voltage) sufficient to maintain a bend alignment and a white image is displayed with the highest voltage (ON voltage) sufficient to raise the liquid crystal molecules arranged in the bend alignment. In the case where the phase difference of the panel to which no voltage is applied (a splay alignment) is about 960 nm and the ON voltage is about 5.0 V, when the biaxial optical compensation films have a phase difference of about 50 nm and an Nz coefficient of about 7.5, the birefringence phase difference between the liquid crystal layer and the biaxial optical compensation films is zero. The Nz coefficient is defined by the equation Nz=(nₓ−n_{z})/(nₓ−n_{y}), wherein nₓ, n_{y}, and n_{z} represent the refractive index of the retardation films in the slow axis direction, that of the retardation films in the fast axis direction, and that of the retardation films in the thickness direction, respectively. In order to perform transmissive display in a normally white mode, conditions for displaying the black image and those for displaying the white image may be replaced with each other. Furthermore, laminates are each placed above or below the panel. The laminates each include a circular polarizer including a polarizing film and ¼ wavelength film that are arranged such that the optical axes thereof make an angle of about 45 degrees.

In order to perform reflective display in a normally black mode, a reflective layer is placed on the inner face (the face in contact with the liquid crystal layer) of one of the substrates that is located on the side opposite the observed face of the panel (including the substrates and the nematic liquid crystal composition, sandwiched therebetween, having positive dielectric anisotropy) or placed on the outer face of this substrate and biaxial optical compensation films (that satisfy the inequality nₓ>n_{y}>n_{z}, wherein x and y represent respective in-plane directions in the panel and z represents the thickness direction of the panel) are provided such that the birefringence phase difference between the liquid crystal layer and the biaxial optical compensation films is equal to zero.

In the case where the phase difference of the panel to which no voltage is applied (a splay alignment) is about 480 nm and the ON voltage is about 5.0 V, when the biaxial optical compensation films have a phase difference of about 50 nm and an Nz coefficient of about 7.5, the birefringence phase difference between the liquid crystal layer and the biaxial optical compensation films is zero. Furthermore, a laminate is placed above the upper face (a face located close to an observer) of the panel. The laminate includes a circular polarizer including a polarizing film and ¼ wavelength film that are arranged such that the optical axes thereof make an angle of about 45 degrees. In order to perform reflective display in a normally white mode, conditions for displaying a black image and those for displaying a white image may be replaced with each other as described above.

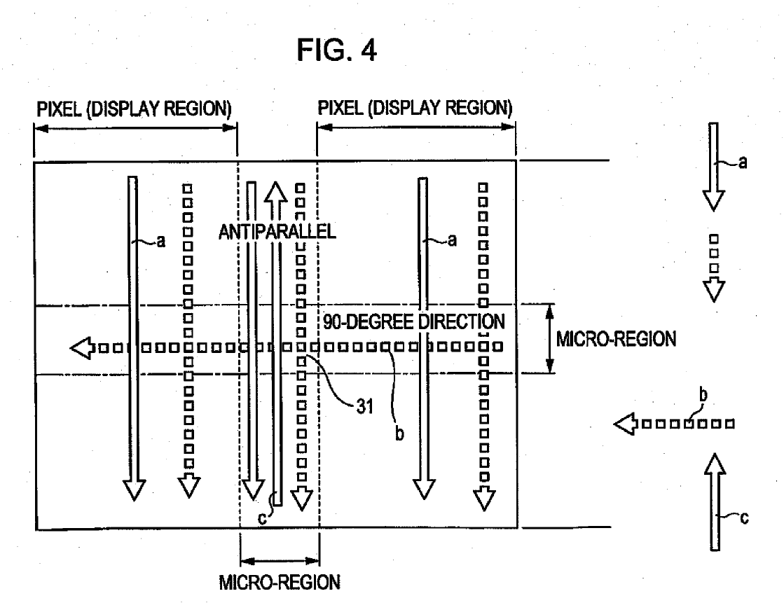

A method for subjecting the first and second substrates 3 and 4 to alignment treatment will now be described in detail. FIG. 4 shows the relationship between a plurality of alignment areas arranged on, for example, the first substrate 3. In this figure, an a direction corresponds to the basic alignment direction (first direction) of the liquid crystal molecules common to the pixels. The first alignment control layer 23, disposed above the first substrate 3, serving as an alignment layer is subjected to first alignment treatment (uniform treatment) such as rubbing treatment in the a direction. The first alignment control layer 23 is made of a polymer such as polyvinyl alcohol, polyamide, or polyimide.

The resulting first alignment control layer 23 exhibits the ability to orient the liquid crystal molecules in the rubbing directions thereof while the pre-tilt angle of the liquid crystal molecules is maintained at a predetermined value. The first alignment control layer 23 may be made of a material containing a polymer (optical alignment polymer) that can be oriented in the linear polarization direction of light, particularly ultraviolet light, having a wavelength of about 200 to 350 nm and preferably about 220 to 280 nm. Examples of such a material include a PBMC polymer material (a type of compound with a side chain having a photoreactive cinnamoyl group and a phenyl group) and a diazo polymer material. In the material, the transition moment of the light absorption of a molecule thereof lies in a specific direction; hence, optical alignment can be exhibited by aligning the polarization direction with the specific direction. In this embodiment, in order to subjecting the first and second alignment control layers 23 and 24 to surface alignment treatment, rubbing treatment and optical alignment treatment are used in combination. In optical alignment treatment, a polarized ultraviolet beam is preferably used.

Second alignment treatment is performed in a b direction (second direction) making an angle of about 90 degrees with the a direction and also in a c direction (third direction) opposite to the a direction such that regions are formed so as to have a width less than that of regions subjected to the first alignment treatment in the a direction. This allows micro-regions 31 to be located at the intersections of regions subjected to the second alignment treatment in the b direction and regions subjected to the second alignment treatment in the c direction. The regions subjected to the second alignment treatment in the b or c direction preferably correspond to portions of the light-shielding black matrix layer 25 and preferably have a width of about 10 to 20 μm when the pixels have a width of about 50 to 90 μm. On the other hand, the second substrate 4 is subjected to third alignment treatment in the same direction (indicated by dotted lines) as the a direction, that is, the first direction, when viewed from above.

In this embodiment, the first alignment control layer 23 has first regions subjected to the first alignment treatment in the first direction and second regions which are subjected to the second alignment treatment in the second direction substantially perpendicular to the first direction and which are also subjected to the second alignment treatment in the third direction opposite to the second direction. The first or second regions may be subjected to optical alignment treatment. In order to perform optical alignment treatment, the first or second regions are selectively irradiated with ultraviolet beams (for example, polarized ultraviolet beams). In this case, the resulting first or second regions may be oriented in the direction substantially parallel to the polarization direction or in the direction substantially perpendicular to the polarization direction.

As described above, in this embodiment, the first alignment treatment performed in the first direction is rubbing treatment and the second alignment treatment performed in the second or third direction is optical alignment treatment. Alternatively, the first alignment treatment may be optical alignment treatment and the second alignment treatment may be rubbing treatment.

The intensity of alignment treatment is preferably set such that the anchoring force of the regions subjected to alignment treatment in the b and/or c direction is less than that of the regions subjected to alignment treatment in the a direction. That is, the following relationship preferably satisfied:

the anchoring force of the regions subjected to alignment treatment in the a direction>the anchoring force of the regions subjected to alignment treatment in the b and/or c direction.

There are various techniques for varying the anchoring force. For rubbing treatment, the anchoring force can be controlled by varying a factor for determining a rubbing strength parameter that semi-quantitatively shows the intensity of rubbing treatment (refer to Y. Sato, K. Sato, and T. Uchida, Jpn. J. Appl. Phys., 31, L579 (1992)). The rubbing strength parameter is defined by the following equation:
L=N×1×(1+2πrn/60v)
wherein N represents the number of times rubbing treatment is performed, l represents the length (contact length) in mm of a zone of a substrate that is brought into contact with a rubbing cloth, r represents the radius in mm of a rubbing roller, n represents the rotation speed in rpm of the rubbing roller, and v represents the traveling speed of a substrate stage. That is, the rubbing strength parameter correlates with the contact length of the substrate zone that is brought into contact with the rubbing cloth within a unit time. As is clear from the above equation, the anchoring force can be controlled by varying the number of times rubbing treatment is performed, the rubbing depth, the radius or rotation speed of the rubbing roller, or the substrate-feeding rate.

Rubbing treatment may be used in combination with, for example, a technique for irradiating a polymer film with light (polarized or not polarized). In this case, the anchoring force may be increased or decreased by selective light irradiation.

In rubbing treatment, the pre-tilt angle of the liquid crystal molecules can be controlled by varying the rubbing strength. In this case, the pre-tilt angle thereof may be increased or decreased in such a manner that the rubbing strength is controlled depending on the molecular structure of the alignment layer.

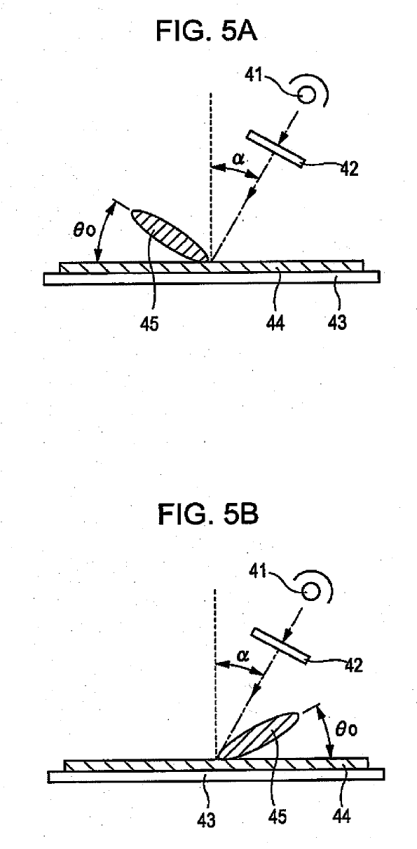

In optical alignment treatment, the anchoring force can be usually controlled by varying the intensity or amount (integrated amount) of light and may be controlled by varying the wavelength of light. In this type of alignment layer, the pre-tilt angle of the liquid crystal molecules is controlled by varying the angle of light incident on the substrate. When light emitted from a light source 41 is incident on an alignment layer 44 lying on a substrate 43 at an angle α, the pre-tilt angle θ₀ of liquid crystal molecules 45 may be controlled as shown in FIG. 5A or 5B.

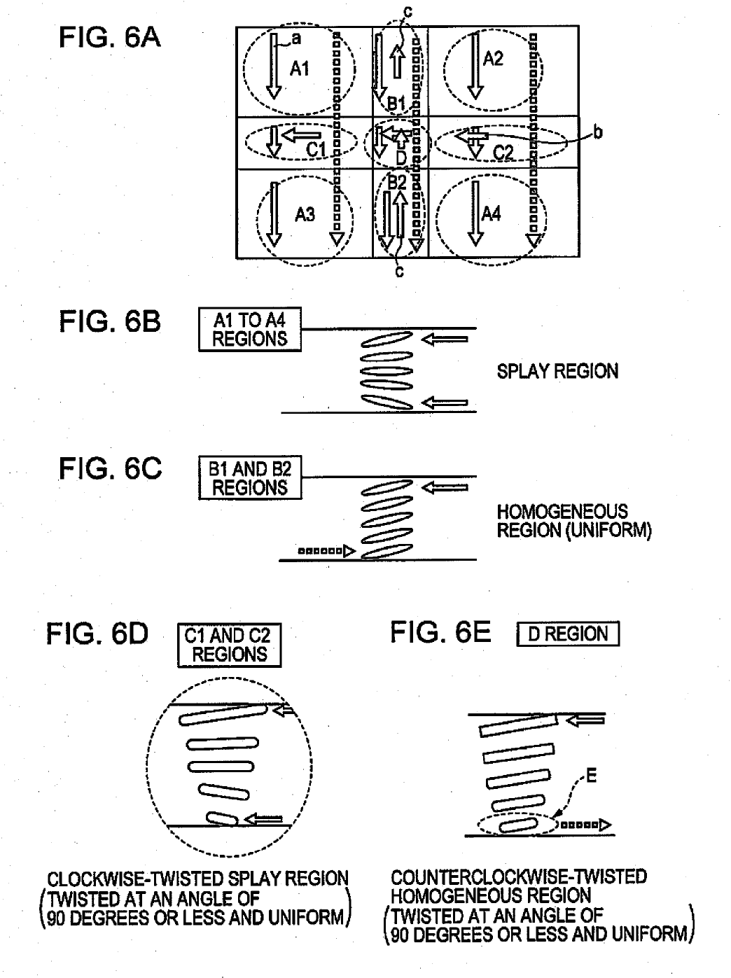

FIG. 6A is a plan view showing the initial alignment of the liquid crystal molecules, to which no voltage is applied, corresponding to the micro-regions subjected to alignment treatment in the a, b, and/or c direction. FIG. 6A shows the locations of the micro-regions shown in FIG. 4. FIGS. 6B to 6E are sectional views showing the liquid crystal molecules viewed in the right direction of FIG. 6A. With reference to FIG. 6B, in A1 to A4 regions subjected to alignment treatment in the same direction, the liquid crystal molecules are arranged in a typical splay alignment. With reference to FIG. 6D, in a C1 region and C2 region that are subjected to alignment treatment such that the anchoring force in the second direction and the anchoring force in the second direction are less than the anchoring force in the first direction, the liquid crystal molecules sandwiched between the first substrate 3 and the second substrate 4 are arranged in a splay alignment such that the liquid crystal molecules are twisted clockwise at an angle (for example, 70 to 88 degrees) less than 90 degrees in the first direction.

With reference to FIG. 6C, in a B1 region and a B2 region, the liquid crystal molecules are arranged between the first and second substrates 3 and 4 such that the liquid crystal molecules are not twisted but are arranged in a homogenous alignment. With reference to FIG. 6E, in a D region located at each intersection, the liquid crystal molecules are twisted counterclockwise from the first substrate 3 to the second substrate 4 at an angle (for example, 88 to 90 degrees) less than or equal to 90 degrees and oriented homogenously. In the D region, an E section is expanded by voltage application.

Since alignment treatment is performed several times, the direction of the pre-tilt angle of the liquid crystal molecules depends on the direction in which alignment treatment performed finally. The orientation direction of each liquid crystal molecule is coincident with the direction of a resultant vector having orientation strength in the orientation direction. In this technique, the liquid crystal molecules can be uniformly twisted at an angle of 90 degrees or less in the C1, C2, and D regions in such a manner that the anchoring force is reduced by reducing the pre-tilt angle.

As described above, the liquid crystal display device 1 is characterized in that alignment treatment is performed such that the following regions are arranged, close to each other, in the narrow regions (micro-regions) between the pixels: the regions where the liquid crystal molecules are arranged in the homogeneous alignment and the regions where the liquid crystal molecules are arranged in the splay alignment, the liquid crystal molecules being twisted in different directions. If voltages greater than or equal to a threshold value are applied to the C1 and C2 regions that are splay regions where the liquid crystal molecules are twisted clockwise at an angle of 90 degrees or less, the C1 and C2 regions are transformed into homogeneous regions where the liquid crystal molecules are twisted counterclockwise at an angle of 90 degrees or more.

This is because the D region that is a homogeneous region where the liquid crystal molecules are twisted counterclockwise at an angle of 90 degrees or less is sandwiched between the C1 and C2 regions and the splay alignment is energetically more stable than the homogeneous alignment during voltage application although the liquid crystal molecules are twisted at an angle of 90 degrees or more. Since the C1 and C2 regions are transformed into the homogeneous regions, the liquid crystal molecules corresponding to the A1 to A4 regions adjacent to the homogeneous regions are twisted at an angle of 90 degrees or more. This reduces the energy barrier for the transformation from the splay alignment to the bend alignment, resulting in the quick transformation to the bend alignment. In one embodiment, such behavior is allowed occur with high density without providing any specific structures on the first and second substrates 3 and 4; hence, the splay alignment can be transformed into the bend alignment with high reproducibility. From such a viewpoint, the angle made by the second direction with the first or third direction is preferably 90±20 degrees and more preferably 90±10 degrees when the liquid crystal panel 2 is viewed from above.

The above transformation can be readily controlled by adjusting the pre-tilt angle of the regions that are subjected to alignment treatment in the a, b, and/or c direction. When the regions subjected to alignment treatment in the a direction have a pre-tilt angle of eight to 15 degrees and the regions subjected to alignment treatment in the b and/or c direction have a pre-tilt angle of three to ten degrees, the splay alignment can be quickly transformed into the bend alignment with high reproducibility.

In one embodiment, the micro-regions may have different orientation directions. For example, the following polymers may be used: an optical alignment polymer of which molecules are oriented in the direction substantially parallel to the polarization direction of light applied to the micro-regions and an optical alignment polymer of which molecules are oriented in the direction substantially perpendicular to the polarization direction of light applied to the micro-regions. Examples of these polymers include azobenzene polymers and other polymers.

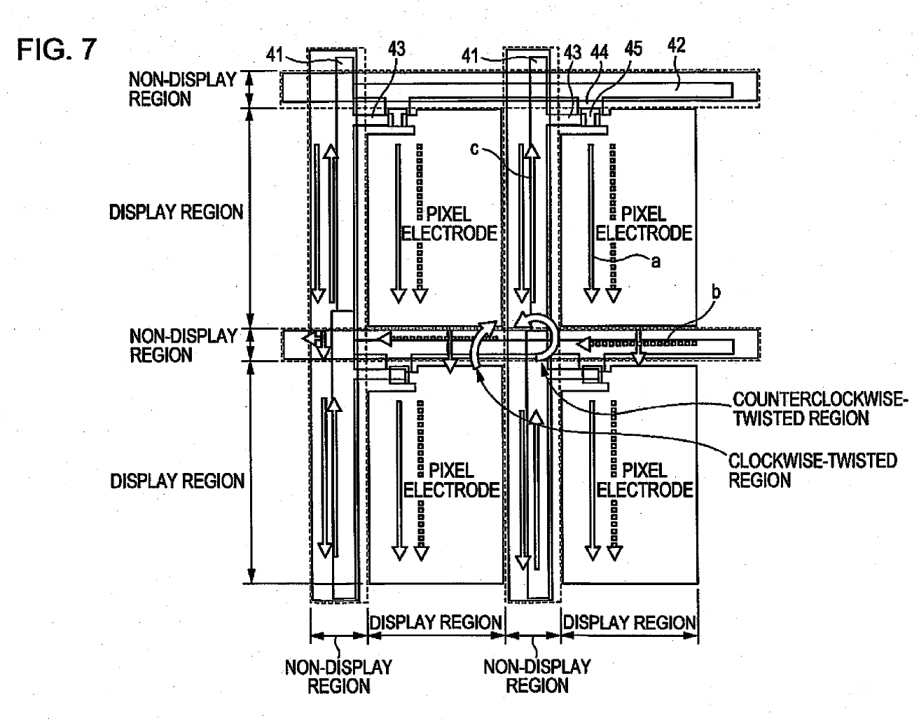

In one embodiment, source electrode lines 41 or gate electrode lines 42 connected to the active driving elements extend in the regions between the pixels; hence, the potential between the source and gate electrode lines 41 and 42 can be used effectively. As shown in FIG. 7, the first substrate 3 is subjected to alignment treatment in the first direction indicated by Arrow a and non-display regions (light-shielding sections of a black mask) located between the pixel electrodes 22 are subjected to alignment treatment in the second direction indicated by indicated by Arrow b and then in the third direction indicated by indicated by Arrow c. This causes micro-regions located on the source and gate electrode lines 41 and 42 to be subjected to alignment treatment; hence, voltages can be applied to the liquid crystal molecules with sources 43 and gates 44 such that the liquid crystal molecules are arranged in the bend alignment. Since the micro-regions are located in the light-shielding sections, disclination regions in which transformation occurs are covered with the light-shielding sections; hence, light leakage caused by the disclination between the micro-regions can be prevented. Reference numeral 45 represents TFTs in this figure.

In one embodiment, various techniques can be used to subject the micro-regions to alignment treatment in different directions. For example, the following techniques can be used: a technique in which mask rubbing is performed in each direction using a template having openings, arranged at the same pitch as that of spaces located between the pixels, having the same width as that of the spaces; a technique in which after all the micro-regions are rubbed, some of the micro-regions are subjected to alignment treatment in the b and c direction and then selectively irradiated with ultraviolet light, which may be polarized or not, using a photomask such that the micro-regions subjected to alignment treatment in the b and c direction have a anchoring force less than that of the micro-regions subjected to alignment treatment in the a direction; a technique in which the micro-regions are masked with a photoresist that can withstand the shear stress caused by rubbing and then rubbed in different directions; and a technique in which an alignment layer is rubbed using a head or tool useful in rubbing a minute area.

In this embodiment, at least one spot at which the splay-bend transformation starts is provided in each pixel. However, the present invention is not limited to this embodiment. The number of the transformation-starting spots may be varied depending on properties (elastic constant, dielectric anisotropy, and the like) of the liquid crystal composition, the panel gap, the pre-tilt angle of the liquid crystal molecules, or the anchoring force. For example, the number of the transformation-starting spots is preferably one per 3 to 100 pixels and more preferably one per 3 to 10 pixels. When one pixel has two to four of the transformation-starting spots, the number of the transformation-starting spots is relatively large and therefore the time taken to cause the splay-bend transformation can be greatly reduced. When the pre-tilt angle is large, for example, four or five to 15 degrees, the splay-bend transformation can readily occur; hence, even if the number of the transformation-starting spots is one per 10 or more pixels, advantages can be achieved.

In one embodiment, after the first regions are subjected to optical alignment treatment, the second regions may be also subjected to optical alignment treatment if stable orientation can be achieved. Alternatively, after the first regions are subjected to optical alignment treatment, the second regions may be subjected to rubbing treatment. In this embodiment, the first and second regions on the active matrix array substrate are subjected to alignment treatment. The counter substrate opposed to the active matrix array substrate may be subjected to alignment treatment.

### EXAMPLES

Examples of the present embodiments will now be described.

### Example 1

As shown in FIG. 2, an active matrix substrate 3 was prepared. A material (a PIA 5500 series product available from Chisso Corporation) for forming a first alignment layer 23 was provided above the active matrix substrate 3 by flexography, dried at about 80° C. for about five minutes, and then fired at about 210° C. for about 30 minutes, whereby the first alignment layer 23 was formed above the active matrix substrate 3. The first alignment layer 23 had a thickness of about 650 \acute{Å}. R, G, and B color filters corresponding to the respective three primary colors were formed above a counter substrate 4 opposed to the active matrix substrate 3 such that the R, G, and B color filters were arranged in a striped pattern as shown in FIG. 1. An ITO layer was formed over the R, G, and B color filters so as to have a sheet resistance of about 10 Ω/square. A second alignment layer 24 was formed on the ITO layer in the same manner as that described above.

A face of the first alignment layer 23 was uniformly rubbed with a rayon cloth (a YA series product available from Yoshikawa Kakou) wound around a rubbing roller in the twelve-to-six o'clock direction with respect to a panel described below. This direction was set to a principal direction (first direction). For rubbing conditions, the radius of the rubbing roller was about 100 mm, the rotation speed of the rubbing roller was about 800 rpm, the rubbing contact length was about 0.25 to 0.30 mm, and the substrate-feeding rate was 30 mm. Under these conditions, the rubbing strength L was about 1,532. The second alignment layer 24 lying above the counter substrate 4 was also rubbed in the same manner as that described above. In this operation, a face of the second alignment layer 24 that was to be directed downward was rubbed in twelve-to-six o'clock direction.

The rubbed face of the first alignment layer 23 was further rubbed with the rubbing roller in the three-to-nine o'clock direction (second direction) with respect to the panel in such a manner that this face was covered with a mask having narrow openings corresponding to spaces, arranged between pixels at a pitch of about 240 μm, having a width about 10 μm. Rubbing conditions of this operation were substantially the same as those described above except that the rotation speed of the rubbing roller was 600 rpm. The rubbing strength L in this operation was about 1,152. Furthermore, this face was rubbed with the rubbing roller in the six-to-twelve o'clock direction (third direction) in such a manner that this face was covered with another mask having narrow openings corresponding to spaces, arranged between pixels at a pitch of about 70 μm, having a width about 10 μm. The third direction was opposite to the first direction. Rubbing conditions in this operation were the same as those in the above operation in which rubbing was performed in the three-to-nine direction. The rubbing strength L in this operation was about 1,140.

Since rubbing was performed repeatedly in different directions as described above, this face of the first alignment layer 23 had regions having different anchoring forces depending on the rubbing directions and/or the rubbing strengths. That is, regions rubbed in the second or third direction had anchoring forces acting in the direction substantially perpendicular or opposite to the direction of the anchoring force of regions rubbed in the first direction.

The active matrix substrate 3 and counter substrate 4 treated as described above were combined with each other as shown in FIG. 1. Spherical resin spacers, available from Sekisui Fine Chemical Co., Ltd., having a particle size of about 6 μm were provided between the active matrix substrate 3 and counter substrate 4. The active matrix substrate 3 and the counter substrate 4 were then bonded to each other with an epoxy sealant (not shown) as shown in FIG. 1, whereby an empty cell was prepared. A nematic liquid crystal which was a fluoride-containing composition available from Chisso Corporation and which had positive dielectric anisotropy was injected between the active matrix substrate 3 and the counter substrate 4. Polarizing films and retardation films were provided on and under the active matrix substrate 3 and the counter substrate 4, whereby the panel was prepared.

In particular, the polarizing films and retardation films were arranged from an observer of the panel as follows: one of the polarizing films, a ¼ wavelength film, a biaxial optical compensation film, the panel, another biaxial optical compensation film, another ¼ wavelength film, and the other one of the polarizing films. The polarizing film disposed above the panel was an iodine-containing polarizer, having a transmittance of about 44% and a polarization degree of about 99.95%, available from Nitto Denko Corporation and was provided above the panel such that the absorption axis of this polarizing film was rotated counterclockwise from the three o'clock direction at an angle of about 45 degrees when viewed from the upper face of the panel. The ¼ wavelength film disposed above the panel was made of polycarbonate and had such wavelength dispersion properties that the phase difference increases with the wavelength. This ¼ wavelength film was provided above the panel such that the slow axis of this ¼ wavelength film was rotated counterclockwise from the three o'clock direction at an angle of about 90 degrees when viewed from the upper face of the panel. The biaxial optical compensation film disposed above the panel was made of polycarbonate and had a phase difference of about 50 nm and an Nz coefficient of about 7.5. This biaxial optical compensation film was provided above the panel such that the slow axis of this biaxial optical compensation film was directed in the three o'clock direction (the direction perpendicular to the rubbing direction of the panel) when viewed from the upper face of the panel. The Nz coefficient is defined by the equation Nz=(nₓ−n_{z})/(nₓ−n_{y}), wherein nₓ, n_{y}, and n_{z} represent the refractive index of this biaxial optical compensation film in the slow axis direction thereof, that of this biaxial optical compensation film in the fast axis direction thereof, and that of this biaxial optical compensation film in the thickness direction thereof, respectively. The biaxial optical compensation film disposed below the panel was made of polycarbonate and had a phase difference of about 50 nm and an Nz coefficient of about 7.5. This biaxial optical compensation film was provided below the panel such that the slow axis of this biaxial optical compensation film was directed in the three o'clock direction (the direction perpendicular to the rubbing direction of the panel) when viewed from the upper face of the panel. The ¼ wavelength film disposed below the panel was made of polycarbonate and had such wavelength dispersion properties that the phase difference increases with the wavelength. This ¼ wavelength film was provided below the panel such that the slow axis of this ¼ wavelength film was directed in the three o'clock direction when viewed from the upper face of the panel. The polarizing film disposed below the panel was an iodine-containing polarizer, having a transmittance of about 44% and a polarization degree of about 99.95%, available from Nitto Denko Corporation and was provided below the panel such that the absorption axis of this polarizing film was rotated counterclockwise from the three o'clock direction at an angle of about 135 degrees when viewed from the upper face of the panel.

Before a voltage was applied to the panel obtained as described above, molecules of the liquid crystal were arranged in a splay alignment in the A1 to A4 regions subjected to alignment treatment in the first direction as shown in FIG. 6B, arranged in a splay alignment in the C1 and C2 regions subjected to alignment treatment in the second direction as shown in FIG. 6D such that the liquid crystal molecules were twisted clockwise at an angle of 90 degrees or less, and arranged in a homogenous alignment in the D region subjected to alignment treatment in the third direction as shown in FIG. 6D such that the liquid crystal molecules were twisted counterclockwise at an angle of 90 degrees or less.

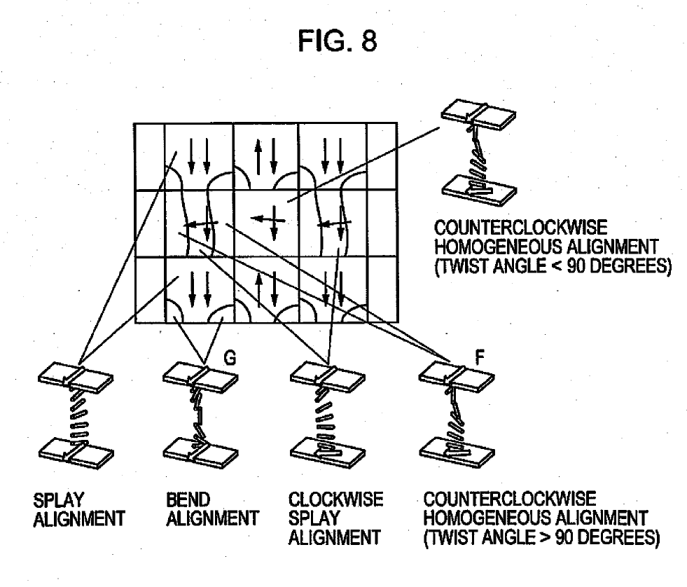

After a voltage was applied to the panel, the following transformation occurred from boundary regions between the regions subjected to alignment treatment in the second direction and the regions subjected to alignment treatment in the third direction toward the regions subjected to alignment treatment in the second direction as shown in FIG. 8: the transformation from a splay alignment in which the liquid crystal molecules were twisted clockwise at an angle of 90 degrees or less to a homogeneous alignment in which the liquid crystal molecules were twisted counterclockwise at an angle of 90 degrees or more. The transformation from the splay alignment to a bend alignment occurred from boundary regions between regions (F) where the liquid crystal molecules were arranged in a homogeneous alignment such that the liquid crystal molecules were twisted counterclockwise at an angle of 90 degrees or more and the regions (G) subjected to alignment treatment in the first direction. When a rectangular wave with a frequency of about 60 Hz was applied to a liquid crystal display device including the panel with an alternating voltage of about 5 V, the time taken to transform the splay alignment to the bend alignment was about 0.38 second. That is, it was confirmed that the transformation from the splay alignment to the bend alignment occurred quickly in the liquid crystal display device. Furthermore, it was confirmed that light leakage due to disclination between regions was prevented from occurring in the liquid crystal display device, that is, the liquid crystal display device had the ability to prevent such light leakage.

### Example 2

In the description of this example, the same figures and reference numerals as those used in Example 1 are used.

As shown in FIG. 2, an active matrix substrate 3 was prepared. A photolytic material containing polyimide was provided above the active matrix substrate 3 by flexography. A first optical alignment layer 23 available from Nissan Chemical Industries was provided on the photolytic material, dried at about 80° C. for about three minutes, and then fired at about 230° C. for about 50 minutes. The resulting first optical alignment layer 23 had a thickness of about 650 \acute{Å}. The first optical alignment layer 23 was subjected to alignment treatment such that the anchoring force thereof was decreased in the polarization direction of polarized ultraviolet light by irradiating the first optical alignment layer 23 with the polarized ultraviolet light and therefore the liquid crystal molecules were oriented in the direction arbitrarily perpendicular to the polarization direction thereof.

In the same manner as described in Example 1, color filters shown in FIG. 1 were formed above a counter substrate 4 by photolithography, an ITO layer was formed over the color filters by a low-temperature sputtering process, and a second alignment layer 24 was formed on the ITO layer.

A face of the first optical alignment layer 23 was uniformly rubbed in the twelve-to-six o'clock direction with respect to a panel, described below, in the same manner as described in Example 1. This direction was set to a principal direction (first direction). Rubbing conditions in this operation were the same as those described in Example 1. The second optical alignment layer 24 lying above the counter substrate 4 was also rubbed in the same manner as that described above. In this operation, a face of the second optical alignment layer 24 that was to be directed downward was rubbed in twelve-to-six o'clock direction.

Optical alignment treatment was performed in such a manner that the rubbed face of the first optical alignment layer 23 was covered with a mask having rectangular openings corresponding to spaces, located between pixels, having a width of about 8 μm and polarized ultraviolet light was applied to the mask in the direction (second direction) that was three degrees rotated from the nine-to-three o'clock direction to the six o'clock direction with respect to the panel. The rectangular openings were arranged at a pitch of about 140 μm and had a length of about 230 μm. The polarization direction of the polarized ultraviolet light was substantially perpendicular to the incident direction thereof. The incident polarized ultraviolet light made about 30 degrees with the normal to the rubbed face of the first optical alignment layer 23. Furthermore, optical alignment treatment was performed using a photomask having openings which had the same size as that of the above openings, which were arranged at the same pitch as that of the above openings, and which were 23 μm shifted in the nine-to-three direction. In this operation, polarized ultraviolet light was applied to the photomask in the direction (third direction) that was three degrees rotated from the nine-to-three o'clock direction to the twelve o'clock direction with respect to the panel. The polarization direction of this polarized ultraviolet light was substantially perpendicular to the incident direction thereof. This polarized ultraviolet light made about 30 degrees with the normal to the rubbed face of the first optical alignment layer 23. Regions partly subjected to optical alignment treatment in the first or second direction had anchoring forces acting in the direction substantially perpendicular to the first direction.

The active matrix substrate 3 and counter substrate 4 treated as described above were then bonded to each other as shown in FIG. 1. A nematic liquid crystal having positive dielectric anisotropy and a refractive index anisotropy Δn of about 0.16 was injected between the active matrix substrate 3 and the counter substrate 4. Polarizing films and retardation films were provided on and under the active matrix substrate 3 and the counter substrate 4, whereby the panel was prepared.

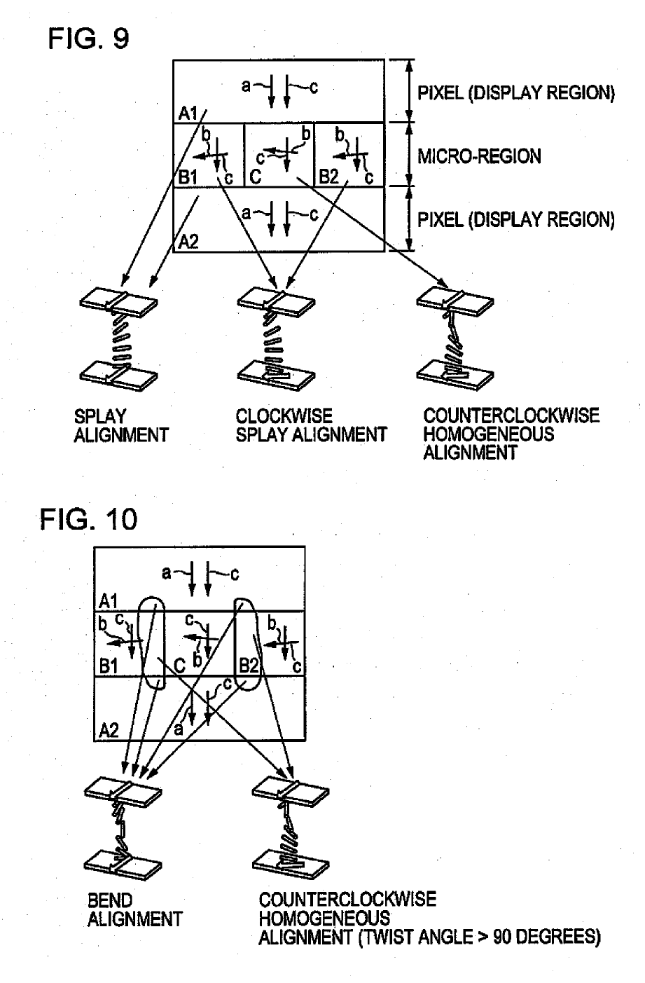

Conditions for arranging the polarizing films and retardation films were the same as those described in Example 1. Before a voltage was applied to the panel obtained as described above, molecules of the liquid crystal were arranged in a splay alignment in A1 and A2 regions subjected to alignment treatment in the first direction as shown in FIG. 9, arranged in a splay alignment in B1 and B2 regions subjected to alignment treatment in the second direction such that the liquid crystal molecules were twisted clockwise at an angle of 90 degrees or less, and arranged in a homogenous alignment in a C region subjected to alignment treatment in the third direction as shown in FIG. 6D such that the liquid crystal molecules were twisted counterclockwise at an angle of 90 degrees or less.

After a voltage was applied to the panel, the following transformation occurred from boundary regions between the regions subjected to alignment treatment in the second direction and the regions subjected to alignment treatment in the third direction toward the regions subjected to alignment treatment in the second direction as shown in FIG. 10: the transformation from a splay alignment in which the liquid crystal molecules were twisted clockwise at an angle of 90 degrees or less to a homogeneous alignment in which the liquid crystal molecules were twisted counterclockwise at an angle of 90 degrees or more. The transformation from the splay alignment to a bend alignment occurred from boundary regions between regions where the liquid crystal molecules were arranged in a homogeneous alignment such that the liquid crystal molecules were twisted counterclockwise at an angle of 90 degrees or more and the regions subjected to alignment treatment in the first direction. Furthermore, the transformation from the splay alignment to the bend alignment occurred from boundary regions (E) between regions where the liquid crystal molecules were arranged in a homogeneous alignment such that the liquid crystal molecules were twisted counterclockwise at an angle of 90 degrees or more and the regions subjected to alignment treatment in the first direction. When a rectangular wave with a frequency of about 60 Hz was applied to a liquid crystal display device including the panel with an alternating voltage of about 5 V, the time taken to transform the splay alignment to the bend alignment was about 0.37 second. That is, it was confirmed that the transformation from the splay alignment to the bend alignment occurred quickly in the liquid crystal display device.

### Example 3

In the description of this example, the same figures and reference numerals as those used in Example 1 are used.

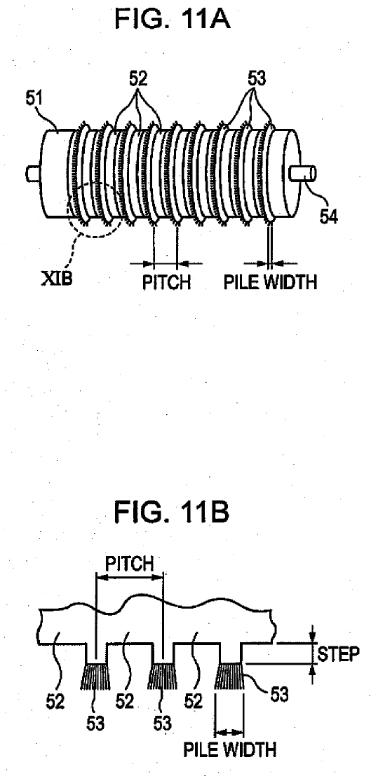

In the same manner as that described in Example 1, an active matrix substrate 3 and a color filter substrate 4 opposed to the first substrate 3 were prepared and a first alignment layer 23 and a second alignment layer 24 were formed above the first and second alignment layers 23 and 24, respectively. A face of the first alignment layer 23 and a face of the second alignment layer 24 were uniformly rubbed in the same manner and under the same conditions as those described in Example 1. The rubbed face of the first alignment layer 23 was further rubbed with a rubbing roller 51 shown in FIGS. 11A and 11B in the three-to-nine direction (second direction) with respect to a panel described below. The rubbing roller 51 had a structure corresponding to spaces, arranged between pixels at a pitch of about 240 μm, having a width of about 10 μm.

The rubbing roller 51 had been prepared as follows: a large number of steps having a width of 11 μm and a height of 1 mm were formed on the curved surface of a roller base member 52 made of metal at a pitch of about 240 μm and rayon piles 53 having a length of about 500 μm and a diameter of about 15 to 20 μm were provided on the steps by electrostatic flocking. With reference to FIG. 11A, reference numeral 54 represents a roller shaft. For rubbing conditions, the rubbing roller 51 had a diameter of about 80 mm, the rotation speed of the rubbing roller 51 was about 700 rpm, the rubbing depth was about 0.30 to 0.35 mm, and the substrate-feeding rate was about 35 mm. Under these rubbing conditions, the rubbing strength L was about 829.

The rubbed face of the first alignment layer 23 was further rubbed with another roller in the six-to-twelve direction (third direction) with respect to the panel. This roller had substantially the same configuration as that of the rubbing roller 51 except that this roller had steps, arranged at a pitch of 70 μm, having a width of 11 μm and a height of 1 mm. Rubbing conditions in this rubbing treatment were the same as those in that rubbing treatment performed in the three-to-nine direction. Under these rubbing conditions, the rubbing strength L was about 841.

The panel was prepared in the same manner as that described in Example 1 using the active matrix substrate 3 and color filter substrate 4 treated as described above. Before a voltage was applied to the panel obtained as described above, molecules of a liquid crystal were arranged in a splay alignment in regions (A1 to A4) subjected to alignment treatment in the first direction, arranged in a splay alignment in regions (C1 and C2) subjected to alignment treatment in the second direction such that the liquid crystal molecules were twisted clockwise at an angle of 90 degrees or less, and arranged in a homogenous alignment in a region (D) subjected to alignment treatment in the third direction such that the liquid crystal molecules were twisted counterclockwise at an angle of 90 degrees or less as shown in FIGS. 6B, 6D, and 6E, respectively.

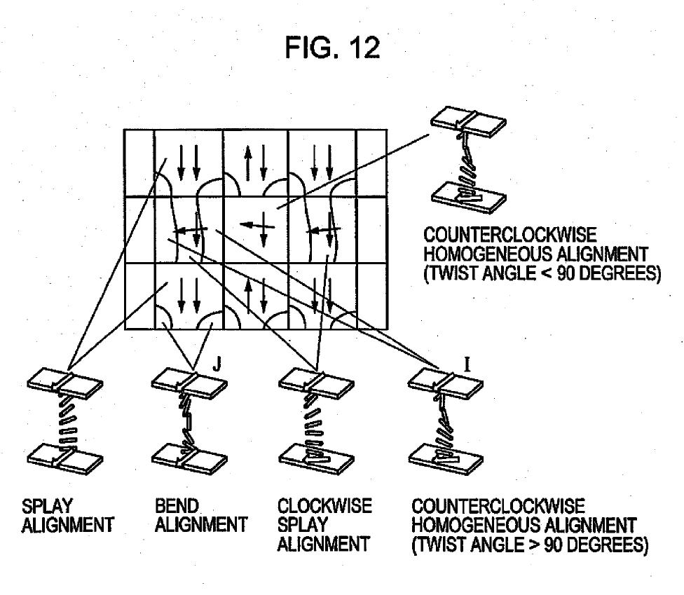

After a voltage was applied to the panel, the following transformation occurred from boundary regions between the regions subjected to alignment treatment in the second direction and the regions subjected to alignment treatment in the third direction toward the regions subjected to alignment treatment in the second direction as shown in FIG. 12: the transformation from a splay alignment in which the liquid crystal molecules were twisted clockwise at an angle of 90 degrees or less to a homogeneous alignment in which the liquid crystal molecules were twisted counterclockwise at an angle of 90 degrees or more. The transformation from the splay alignment to a bend alignment occurred from boundary regions between regions (I) where the liquid crystal molecules were arranged in a homogeneous alignment such that the liquid crystal molecules were twisted counterclockwise at an angle of 90 degrees or more and the regions subjected to alignment treatment in the first direction (J). When a rectangular wave with a frequency of about 60 Hz was applied to a liquid crystal display device including the panel with an alternating voltage of about 5 V, the time taken to transform the splay alignment to the bend alignment was about 0.35 second. That is, it was confirmed that the transformation from the splay alignment to the bend alignment occurred quickly in the liquid crystal display device. Furthermore, it was confirmed that light leakage due to disclination between regions was prevented from occurring in the liquid crystal display device, that is, the liquid crystal display device had the ability to prevent such light leakage.

### Example 4

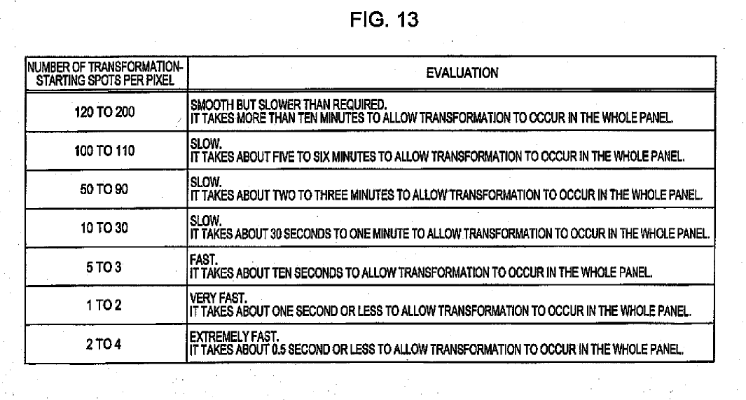

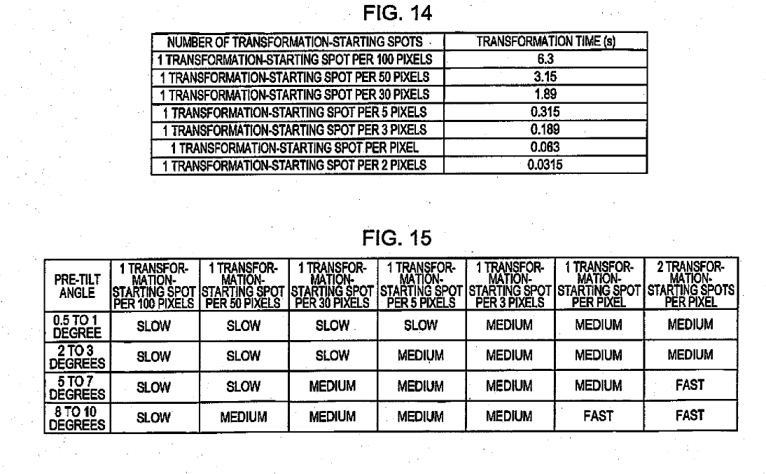

First alignment layers 23 were formed above respective active matrix substrates 3 and second alignment layers 24 were formed above respective color filter substrates 4 opposed to the active matrix substrates 3 in the same manner as that described in Example 1. The first and second alignment layers 23 and 24 had a pre-tilt angle of three to four degrees. A face of each first alignment layer 23 and a face of each second alignment layer 24 were uniformly rubbed in the same manner and under the same conditions as those described in Example 1. In order to vary the number of spots at which transformation starts, the rubbed faces of the first alignment layers 23 were further rubbed with the rubbing roller used in Example 3 under the same conditions as those described in Example 3 in such a manner that the pitch of the steps of the rubbing roller was varied several times. Panels were prepared in the same manner as that described in Example 1 using the active matrix substrates 3 and the color filter substrates 4. The relationship between the number of the transformation-starting spots and the time taken to cause the transformation to a bend alignment was investigated in such a manner that rectangular waves with a frequency of about 60 Hz were applied to the panels with an alternating voltage of about 5 V. FIG. 13 shows the results of the investigation.

In panels for practical use, the time taken to cause the transformation to the bend alignment is preferably short. As shown in FIG. 13, an increase in the number of the transformation-starting spots reduces the time taken to cause the transformation to the bend alignment in the panels. In order to reduce the time taken to cause the transformation to one second or less when rectangular waves with a frequency of about 60 Hz are applied to the panels with an alternating voltage of about 5 V, the number of the transformation-starting spots needs to be two or more per pixel.

### Example 5

Four types of films were used to prepare panels having the same configuration as that of the panels described in Example 4. The films had a pre-tilt angle of 0.5 to one degree, two to three degrees, five to seven degrees, or eight to ten degrees, respectively. First alignment layers 23 and second alignment layers 24 were formed above active matrix substrates 3 and color filter substrates 4 opposed to the active matrix substrates 3 using the films. A face of each first alignment layer 23 and a face of each second alignment layer 24 were uniformly rubbed in the same manner and under the same conditions as those described in Example 1 and then subjected to alignment treatment in the same manner as that described in Example 3 such that the number of spots at which transformation starts was varied. Panels were prepared in the same manner as that described in Example 1 using the active matrix substrates 3 and the color filter substrates 4.

The relationship between the number of the transformation-starting spots and the time taken to cause the transformation to a bend alignment was investigated in such a manner that rectangular waves with a frequency of about 60 Hz were applied to the panels with an alternating voltage of about 5 V. FIG. 15 shows the results of the investigation. The panels in which the time taken to allow the transformation to a bend alignment to occur in the whole panels is less than one second are evaluated to be fast, those in which the time is one second or more and less than one minute are evaluated to be medium, and those in which the time is one minute or more are evaluated to be slow, because practical panels display images in a bend alignment mode. As is clear from FIG. 15, an increase in the pre-tilt angle and an increase in the number of the transformation-starting spots reduce the time taken for the transformation.

### Example 6

First alignment layers 23 were formed above respective active matrix substrates 3 and second alignment layers 24 were formed above respective color filter substrates 4 opposed to the active matrix substrates 3 in the same manner as that described in Example 1. A face of each first alignment layer 23 and a face of each second alignment layer 24 were uniformly rubbed in a first direction in the same manner and under the same conditions as those described in Example 1. The rubbed face of the first alignment layer 23 was further rubbed in a second direction and then in a third direction in the same manner as that described in Example 1 in such a state that the rubbed face thereof was covered with a mask having narrow openings corresponding to spaces, arranged between pixels at a pitch of about 240 μm), having a width about 10 μm. In this operation, regions of the rubbed face thereof were rubbed in the second direction with a rubbing strength L of about 700 to 850 or about 200 to 300. Panels were prepared in substantially the same manner as that described in Example 1 except that the regions rubbed in the second direction with different rubbing strengths.

Before a voltage was applied to each panel obtained as described above, molecules of a liquid crystal were arranged in a splay alignment in regions (A1 to A4) subjected to alignment treatment in the first direction, arranged in a splay alignment in regions (C1 and C2) subjected to alignment treatment in the second direction with a rubbing strength of about 700 to 850 such that the liquid crystal molecules were twisted clockwise at an angle of 80 to 89 degrees, and arranged in a homogenous alignment in a region (D) subjected to alignment treatment in the third direction such that the liquid crystal molecules were twisted counterclockwise at an angle of 90 degrees or less as shown in FIGS. 6B, 6D, and 6E, respectively.

After a voltage was applied to the panel, the following transformation occurred from boundary regions between the regions subjected to alignment treatment in the second direction and the regions subjected to alignment treatment in the third direction toward the regions subjected to alignment treatment in the second direction as shown in FIG. 8 without depending on the rubbing strength of the regions subjected to alignment treatment in the second direction: the transformation from a splay alignment in which the liquid crystal molecules were twisted clockwise at an angle of 80 to 89 degrees to a homogeneous alignment in which the liquid crystal molecules were twisted counterclockwise at an angle of 91 to 100 degrees. The transformation from the splay alignment to a bend alignment occurred from boundary regions between regions (F) where the liquid crystal molecules were arranged in a homogeneous alignment such that the liquid crystal molecules were twisted counterclockwise at an angle of 90 degrees or more and the regions (G) subjected to alignment treatment in the first direction. In the regions (C1 and C2) that were subjected to the second direction with a rubbing strength L of about 200 to 300, the liquid crystal molecules were arranged in a splay alignment such that the liquid crystal molecules were twisted clockwise at an angle of about 70 to 80 degrees. In other regions (A1 to A4 and D), the alignment of the liquid crystal molecules was the same as described above.

In the panels to which voltages were applied, the following transformation did not occur in some of the regions (C1 and C2) which were subjected to alignment treatment in the second direction and in which the liquid crystal molecules were arranged in a splay alignment such that the liquid crystal molecules were twisted clockwise at an angle of about 70 to 80 degrees: the transformation from a splay alignment in which the liquid crystal molecules were twisted clockwise at an angle of about 70 to 75 degrees to a homogeneous alignment in which the liquid crystal molecules were twisted counterclockwise at an angle of about 100 to 110 degrees. This is probably because a rubbing strength L of about 200 to 300 is insufficient to prevent rubbing defects and/or the splay alignment in which the liquid crystal molecules were twisted clockwise at an angle of about 70 to 80 degrees is energetically more stable than the homogeneous alignment in which the liquid crystal molecules were twisted counterclockwise at an angle of about 100 to 110 degrees even if voltages are applied to the panels.

### Comparative Example

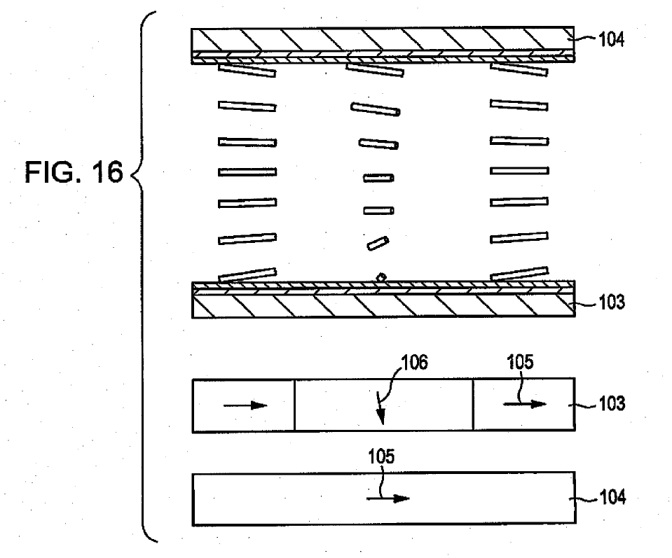

A first alignment layer and a second alignment layer were formed above an active matrix substrate 103 and a color filter substrate 104 opposed to the active matrix substrate 103 in the same manner as that described in Example 1. A face of the first alignment layer was uniformly rubbed in a direction indicated by a first arrow represented by reference numeral 105 shown in FIG. 16 in the same manner and under the same conditions as those described in Example 1. Furthermore, the rubbed face of the first alignment layer was partly rubbed in a direction indicated by a second arrow represented by reference numeral 106 shown in FIG. 16 in such a state that the rubbed face thereof was covered with a mask having narrow openings corresponding to spaces, arranged between pixels at a pitch of about 240 μm, having a width about 10 μm. The direction indicated by the second arrow 106 made an angle of about 85 degrees with the direction perpendicular to a panel described below. Rubbing conditions in this operation were the same as those in that operation. In this operation, the rubbing strength L was about 1,532. A panel was prepared in the same manner as that described in Example 1 using the active matrix substrate 103 and the color filter substrate 104.

Before a voltage was applied to the panel obtained as described above, molecules of a liquid crystal were arranged in a splay alignment in regions subjected to alignment treatment in the direction indicated by the first arrow 105 or arranged in a splay alignment in regions subjected to alignment treatment in the direction indicated by the second arrow 106 such that the liquid crystal molecules were twisted clockwise at an angle of about 85 degrees.

When a voltage was applied to the panel for 30 seconds, the following transformation occurred in some of the regions subjected to alignment treatment in the direction indicated by the second arrow 106: the transformation from a splay alignment in which the liquid crystal molecules were twisted clockwise at an angle of about 85 degrees to a homogeneous alignment in which the liquid crystal molecules were twisted counterclockwise at an angle of about 95 degrees. The transformation from a splay alignment to a bend alignment occurred in the regions subjected to alignment treatment in the direction indicated by the first arrow 105 from boundary regions between the regions where the liquid crystal molecules were rearranged in the homogeneous alignment such that the liquid crystal molecules were twisted counterclockwise at an angle of about 95 degrees and the regions subjected to alignment treatment in the direction indicated by the first arrow 105. However, the following transformation did not occur in other panels manufactured in the same manner as that described above even if voltages were applied to these panels for a long time: the transformation from a splay alignment in which molecules of a liquid crystal were twisted clockwise at an angle of about 85 degrees to a homogeneous alignment in which the liquid crystal molecules were twisted counterclockwise at an angle of about 95 degrees. Therefore, the transformation from the splay alignment to a bend alignment did not also occur.

The following transformation occurred from rubbing defects present in some of the regions where the liquid crystal molecules were twisted clockwise: the transformation from the splay alignment in which the liquid crystal molecules were twisted clockwise at an angle of about 85 degrees to the homogeneous alignment in which the liquid crystal molecules were twisted counterclockwise at an angle of about 95 degrees. However, the absence of the rubbing defects did not cause the transformation. Even if the transformation occurred from the rubbing defects, the number of the rubbing defects is small and the rubbing defects are present at random. Hence, voltages need to be applied to these panels for a long time to allow the following transformation to occur in all regions where the liquid crystal molecules are arranged in a splay alignment such that the liquid crystal molecules are twisted clockwise: the transformation from the splay alignment in which the liquid crystal molecules are twisted clockwise to a homogeneous alignment in which the liquid crystal molecules are twisted counterclockwise. For example, when rectangular waves with a frequency of about 60 Hz were applied to these panels with an alternating voltage of about 5 V, it takes about three minutes to allow the following transformation to occur in all regions where the liquid crystal molecules are arranged in a splay alignment such that the liquid crystal molecules are twisted clockwise: the transformation from the splay alignment in which the liquid crystal molecules are twisted clockwise to the homogeneous alignment in which the liquid crystal molecules are twisted counterclockwise. Since the transformation to a bend alignment occurs primarily in regions in contact with regions where the liquid crystal molecules are arranged in the homogeneous alignment such that the liquid crystal molecules are twisted counterclockwise, it takes about three minutes to allow the transformation to the bend alignment to occur in these whole panels after voltages are applied to these panels.

Although a liquid crystal display device according to one embodiment has a simple panel structure and can be manufactured by a simple process, the transformation from a splay alignment to a bend alignment is allowed to occur quickly in the liquid crystal display device with a small voltage of several volts with high reproducibility. This is because the transformation, which is the key to allow OCB-mode liquid crystal display devices to display images, starts at spots which have a fine width, which are present in a wide region uniformly subjected to alignment treatment, and which are subjected to alignment treatment in two different directions. Therefore, the liquid crystal display device is suitable for potable apparatuses and which has low power consumption, a wide viewing angle, and high response speed. The liquid crystal display device can be readily manufactured at low cost. Micro-regions are arranged in light-shielding sections; hence, disclination regions located near the spots at which the transformation starts can be covered with the light-shielding sections. Furthermore, according to one embodiment, a liquid crystal display device including a panel in which bend transformation occurs quickly can be manufactured at low cost without providing fine structures above a substrate at high density and without using a complicated process. This liquid crystal display device is suitable for potable apparatuses and has low power consumption.

While the invention has been described above by reference to various embodiments, it should be understood that many changes and modifications can be made without departing from the scope of the invention. For example, values, materials, the configuration of a liquid crystal display device, and the like are not particularly limited. It is therefore intended that the foregoing detailed description be regarded as illustrative rather than limiting, and that it be understood that it is the following claims, including all equivalents, that are intended to define the spirit and scope of this invention.

1. A liquid crystal display device comprising:
a pair of substrates including electrodes and alignment control layers; and
a liquid crystal layer, disposed between the substrates, having positive dielectric anisotropy,
wherein the alignment control layers are surface alignment treated such that liquid crystal molecules, which are contained in the liquid crystal layer and are located close to the alignment control layers, make pre-tilt angles with the substrates in directions opposite to each other in at least an initial state.

2. The liquid crystal display device according to claim 20, wherein the micro-regions have a small width and are arranged above an active matrix substrate.

3. The liquid crystal display device according to claim 1, further comprising at least one polarizing film and a plurality of retardation films located outside the substrates.

4. A method for manufacturing a liquid crystal display device comprising:
preparing a first and a second substrate including electrodes and alignment control layers;
subjecting the alignment control layers to surface alignment treatment such that liquid crystal molecules which are contained in a liquid crystal layer and which are located close to the alignment control layers make pre-tilt angles with the first and second substrates in directions opposite to each other in at least an initial state and the transformation from a splay alignment to a buffer layer is allowed to occur by voltage application in such a manner that the twist alignment of the liquid crystal molecules is transformed to twist alignments different from each other;
forming micro-regions from which spots at which the transformation starts arise in light-shielding sections;
arranging the first and second substrates such that the electrodes are opposed to the alignment control layers; and
providing the liquid crystal layer between the first and second substrates.

5. The method according to claim 4, wherein subjecting the alignment control layers to the surface alignment treatment includes:
subjecting the alignment control layers to first alignment treatment in a first direction;
subjecting narrow regions present in the alignment control layers to second alignment treatment in a second direction substantially perpendicular to the first direction and then in a third direction opposite to the first direction,
wherein subjecting narrow regions to second alignment treatment is subsequent to subjecting the alignment control layers to first alignment treatment; and
subjecting the alignment control layer of the substrate opposed to the substrate having the alignment control layer subjected to the first alignment treatment and the second alignment treatment to third alignment treatment in a direction that is substantially the same as the first direction.

6. The method according to claim 4, wherein the second direction makes an angle of about 90±20 degrees with the first direction.

7. The method according to claim 5, wherein the anchoring forces of the alignment control layers subjected to the first alignment treatment and the second alignment treatment are controlled such that the first direction is greater than the second and/or third direction.

8. A liquid crystal display device comprising:
a pair of substrates including electrodes and alignment control layers; and
a liquid crystal layer, disposed between the substrates, having positive dielectric anisotropy,
wherein the alignment control layers are surface alignment treated such that liquid crystal molecules which are contained in the liquid crystal layer and which are located close to the alignment control layers make pre-tilt angles with the substrates in directions opposite to each other in at least an initial state and the transformation from a splay alignment to a buffer layer is allowed to occur by voltage application in such a manner that the twist alignment of the liquid crystal molecules is once transformed to twist alignments different from each other, spots at which the transformation starts are micro-regions arranged over a face of a panel, and the alignment control layers include regions subjected to optical alignment treatment.

9. The liquid crystal display device according to claim 8, wherein the alignment control layers include first regions uniformly first alignment treated in a first direction and second regions formed by subjecting the micro-regions present in the alignment control layers to second alignment treatment, subsequent to first alignment treatment, in a second direction substantially perpendicular to the first direction and in a third direction opposite to the first direction.

10. The liquid crystal display device according to claim 9, wherein the second regions are optical alignment treated.

11. The liquid crystal display device according to claim 10, wherein the second regions exhibit alignment properties in a direction substantially parallel to the polarization direction.

12. The liquid crystal display device according to claim 10, wherein the second regions exhibit alignment properties in a direction substantially perpendicular to the polarization direction.

13. The liquid crystal display device according to claim 8, wherein the micro-regions are arranged above an active matrix substrate.

14. A method for manufacturing a liquid crystal display device comprising:
preparing a first substrate including an electrode and a second substrate including an alignment control layer;
subjecting the alignment control layer to surface alignment treatment such that liquid crystal molecules which are contained in a liquid crystal layer and which are located close to the alignment control layer of the second substrate make pre-tilt angles with the first and second substrates in directions opposite to each other in at least an initial state and the transformation from a splay alignment to a buffer layer is allowed to occur by voltage application in such a manner that the twist alignment of the liquid crystal molecules is once transformed to twist alignments different from each other; and
providing the liquid crystal layer between the first and second substrates,
wherein subjecting the alignment control layer to the surface alignment treatment includes;
subjecting the alignment control layer to first alignment treatment in a first direction;
subjecting micro-regions present in the alignment control layer to second alignment treatment in a second direction substantially perpendicular to the first direction and then in a third direction opposite to the first direction, this act being subsequent to subjecting the alignment control layer to first alignment treatment; and
subjecting the alignment control layer of the substrate, opposed to the substrate having the alignment control layer subjected to the first alignment treatment and the second alignment treatment, to third alignment treatment in a direction that is substantially the same as the first direction and the first alignment treatment and the second alignment treatment include optical alignment treatment.

15. The method according to claim 14, wherein the anchoring force of the alignment control layer are controlled such that the first direction is greater than the second and/or third direction.

16. The method according to claim 14, wherein the first alignment treatment is rubbing treatment and the second alignment treatment performed in the second or third direction is optical alignment treatment.

17. The method according to claim 14, wherein the first alignment treatment is optical alignment treatment and the second alignment treatment performed in the second or third direction is rubbing treatment.

18. The method according to claim 16, wherein the optical alignment treatment provides orientation properties to a photo-orientable polymer using polarized ultraviolet light.

19. The liquid crystal display device according to claim 1, wherein the transformation from a splay alignment to a buffer layer is allowed to occur by voltage application in such a manner that the twist alignment of the liquid crystal molecules is transformed to twist alignments different from each other.

20. The liquid crystal display device according to claim 1, wherein spots at which the transformation starts are micro-regions arranged over a face of a panel, and the micro-regions are arranged in light-shielding sections.
